(19) United States
(12) Patent Application Publication
(10) Pub. No.: US 2026/0034491 A1
(43) Pub. Date: Feb. 5, 2026

(54) HONEYCOMB STRUCTURE AND METHOD FOR MANUFACTURING SAME

(71) Applicant: NGK INSULATORS, LTD., Nagoya-City (JP)

(72) Inventors: Koji MOTOKI, Nagoya-Shi (JP); Hiroaki HAYASHI, Nagoya-Shi (JP)

(73) Assignee: NGK INSULATORS, LTD., Nagoya-City (JP)

(21) Appl. No.: 18/598,240

(22) Filed: Mar. 7, 2024

(30) Foreign Application Priority Data
Mar. 30, 2023 (JP) 2023-056768

(51) Int. Cl. B01D 46/24; B01D 46/00; B01J 35/57

(52) U.S. Cl. CPC B01D 46/2429; B01D 46/0001; B01D 46/24491; B01D 46/24492; B01D 46/24494; B01D 46/2498; B01J 35/57

(57) ABSTRACT

A honeycomb structure includes a plurality of cell channels passing through an inside of the honeycomb structure and partitioned by porous partition walls, wherein the honeycomb structure includes 80.0 to 94.0% by mass of cordierite as a main crystalline phase and ceria contained in a secondary crystalline phase; the porous partition walls have a porosity of 60% or more as measured by a mercury porosimetry; and for the porous partition walls, a cumulative 10% pore diameter (D10), a cumulative 50% pore diameter (D50) and a cumulative 90% pore diameter (D90) from a small pore side satisfy a relationship (D90−D10)/D50≤1.2, in a volume-based cumulative pore diameter distribution as measured by the mercury porosimetry.

### CROSS REFERENCE TO RELATED APPLICATIONS

The present invention claims the benefit of priority to Japanese Patent Application No. 2023-56768 filed on Mar. 30, 2023 with the Japanese Patent Office, the entire contents of which are incorporated herein by reference in its entirety.

### FIELD OF THE INVENTION

The present invention relates to a honeycomb structure and a method for manufacturing the same.

### BACKGROUND OF THE INVENTION

Exhaust gas emitted from internal combustion engines such as diesel engines contains large amounts of particulate matter whose main component is carbon, which causes environmental pollution. Therefore, the exhaust system of a diesel engine or the like is generally equipped with a filter (Diesel Particulate Filter: DPF) for collecting particulates. Furthermore, in recent years, particulates emitted from gasoline engines have become a problem, and gasoline engines are also being equipped with filters (Gasoline Particulate Filters: GPFs).

Honeycomb structures are often used in such filters. Furthermore, cordierite is often used as a material constituting a honeycomb structure due to its high thermal shock resistance. A porous honeycomb structure whose main component is cordierite can be manufactured by a method comprising kneading the raw material composition obtained by appropriately adding a cordierite-forming raw material, a dispersion medium, a pore-forming material, a binder, and various additives to form a green body, then extrusion molding it through a predetermined die to prepare a honeycomb-shaped formed body (honeycomb formed body), and then drying and firing the honeycomb formed body.

Conventionally, honeycomb structures whose main component is cordierite have been required to have a high amount of cordierite crystals (phase) in order to ensure thermal shock resistance due to low thermal expansion and to increase strength. Various raw material compositions and firing conditions have been studied (Patent Literature 1 to 3).

In addition, porosity and pore diameter distribution are known as the parameters that influence the performance of honeycomb structures.

Further, techniques to control the porosity and pore diameter distribution have been developed to improve mechanical strength, coefficient of thermal expansion, and the like, and to reduce pressure loss when exhaust gas flows (Patent Literature 4 to 8).

### PRIOR ART

### Patent Literature

[Patent Literature 1] Japanese Patent Application Publication No. 2008-207978
[Patent Literature 2] Japanese Patent Application Publication No. H06-263528
[Patent Literature 3] Japanese Patent Application Publication No. 2002-530262
[Patent Literature 4] Japanese Patent Application Publication No. 2009-542570
[Patent Literature 5] Japanese Patent Application Publication No. 2019-506289
[Patent Literature 6] WO 2016/152236
[Patent Literature 7] WO 2013/047908
[Patent Literature 8] Japanese Patent Application Publication No. 2018-030105

### SUMMARY OF THE INVENTION

On the other hand, in a honeycomb structure having a high amount of cordierite crystals (phase), there is still room for improvement in terms of achieving both high particulate collection efficiency and low pressure loss performance, and further performance improvement is required.

The present invention has been made in view of the above circumstances, and an object in one embodiment of the present invention is to provide a honeycomb structure that can achieve both high particulate collection efficiency and low pressure loss performance at a higher level, while taking advantage of the excellent thermal shock resistance which is a characteristic of crystalline cordierite. Further, an object in another embodiment of the present invention is to provide a method for manufacturing such a honeycomb structure.

The present inventors have discovered that cordierite crystals synthesized (fired) from multiple raw materials such as magnesia source, silica source, and alumina source tend to have a broad pore diameter distribution, which makes it difficult to achieve both high particulate collection efficiency and low pressure loss performance. The present invention was completed based on this finding, and is exemplified as below.

### Aspect 1

A honeycomb structure, comprising a plurality of cell channels passing through an inside of the honeycomb structure and partitioned by porous partition walls,
wherein the honeycomb structure comprises 80.0 to 94.0% by mass of cordierite as a main crystalline phase and ceria contained in a secondary crystalline phase;
the porous partition walls have a porosity of 60% or more as measured by a mercury porosimetry; and
for the porous partition walls, a cumulative 10% pore diameter (D10), a cumulative 50% pore diameter (D50) and a cumulative 90% pore diameter (D90) from a small pore side satisfy a relationship (D90−D10)/D50≤1.2, in a volume-based cumulative pore diameter distribution as measured by the mercury porosimetry.

### Aspect 2

The honeycomb structure according to aspect 1, wherein the porous partition walls have a cumulative 50% pore diameter (D50) of 10 to 20 μm.

### Aspect 3

The honeycomb structure according to aspect 1 or 2, wherein the porous partition walls have a cumulative 10% pore diameter (D10) of 8 μm or more and a cumulative 90% pore diameter (D90) of 34 μm or less.

### Aspect 4

The honeycomb structure according to any one of aspects 1 to 3, wherein the secondary crystalline phase further contains one or more compounds selected from mullite, spinel, sapphirine, and cristobalite.

### Aspect 5

The honeycomb structure according to aspect 4, wherein a total content of ceria and one or more compounds selected from mullite, spinel, sapphirine, and cristobalite is 4.0 to 20.0% by mass.

### Aspect 6

The honeycomb structure according to any one of aspects 1 to 5, wherein a content of ceria is 0.5 to 5.0% by mass.

### Aspect 7

The honeycomb structure according to any one of aspects 1 to 6, wherein a coefficient of linear thermal expansion from 40° C. to 800° C. in a direction in which the cell channels extend is 0.6×10⁻⁶/K to 2.0×10⁻⁶/K.

### Aspect 8

A method for manufacturing a honeycomb structure, comprising:
a step of obtaining a honeycomb formed body comprising a plurality of cell channels passing through an inside of the honeycomb formed body and partitioned by porous partition walls by kneading a raw material composition comprising a cordierite-forming raw material, ceria, a dispersion medium, a pore-forming material, and a binder to form a green body, and then extrusion molding the green body; and
a step of firing the honeycomb formed body;
wherein in the step of firing, assuming a maximum temperature during the firing is X (° C.), a holding time at the maximum temperature is Y (hr), and a content of ceria with respect to 100 parts by mass of the cordierite-forming raw material in the honeycomb formed body is Z (parts by mass), the step of firing is performed such that 160≤(X−1345)×Y×(Z+0.5)²≤7680 is satisfied.

According to one embodiment of the invention, it is possible to achieve both high particulate collection efficiency and low pressure loss performance at a higher level, while taking advantage of the excellent thermal shock resistance which is a characteristic of crystalline cordierite. Therefore, the honeycomb structure can be suitably used as a filter that requires high performance.

### BRIEF DESCRIPTION OF THE DRAWINGS

FIG. 1 is a perspective view schematically showing a wall-through type honeycomb structure.

FIG. 2 is a schematic cross-sectional view of a wall-through type honeycomb structure when observed in a cross-section parallel to the direction in which the cells extend.

FIG. 3 is a perspective view schematically showing a wall flow type pillar-shaped honeycomb structure.

FIG. 4 is a schematic cross-sectional view of a wall-flow type pillar-shaped honeycomb structure as viewed from a cross-section parallel to the direction in which the cells extend.

FIG. 5 is an explanatory diagram schematically showing an example of a method for forming sealing portions using a squeegee method.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### 1. Honeycomb Structure

A honeycomb structure according to an embodiment of the present invention has a plurality of cell channels passing through the honeycomb structure and partitioned by porous partition walls. In one embodiment, the honeycomb structure is provided as a wall-through type or wall flow type pillar-shaped honeycomb structure. There are no particular restrictions on the use of the honeycomb structure. For example, it is used in various industrial applications such as heat sinks, filters (for example, GPF, DPF), catalyst carriers, sliding parts, nozzles, heat exchangers, electrical insulation members, and parts for semiconductor manufacturing equipment. Among these, it can be suitably used as a filter that collects particulate matter contained in exhaust gas from internal combustion engines, boilers, and the like, and as a catalyst carrier for exhaust gas purification catalysts. In particular, the honeycomb structure can be suitably used as an automobile exhaust gas filter and/or a catalyst carrier.

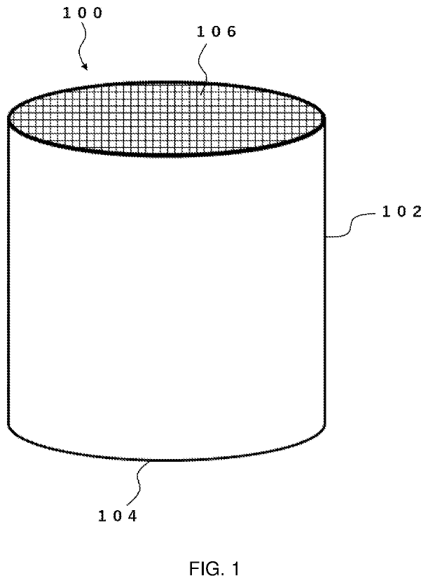

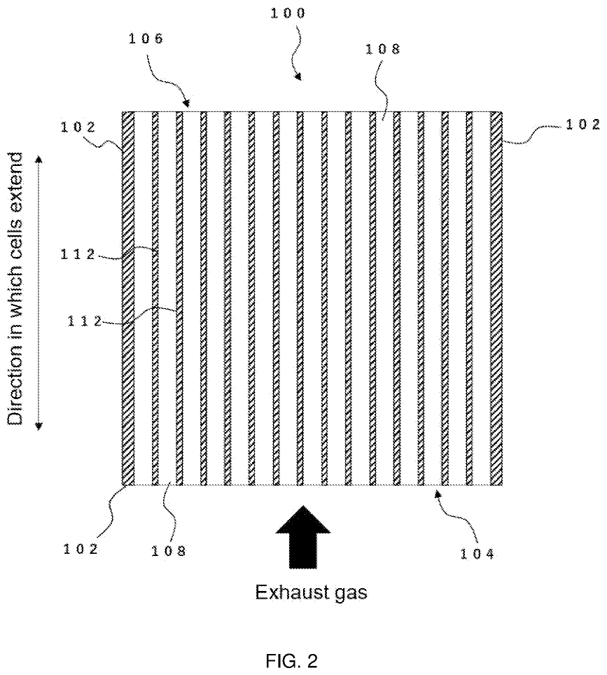

FIGS. 1 and 2 illustrate a schematic perspective view and a cross-sectional view of a wall-through type honeycomb structure 100, respectively. This honeycomb structure 100 comprises an outer peripheral side wall 102; and porous partition walls 112 disposed on the inner peripheral side of the outer peripheral side wall 102 and partitioning a plurality of cells 108 that form fluid flow paths (cell channels) from a first end surface 104 to a second end surface 106. In this honeycomb structure 100, both ends of each cell 108 are open, and the exhaust gas that flows into one cell 108 from the first end surface 104 is purified while passing through the cell and flows out from the second end surface 106. It should be noted that, although the first end surface 104 is defined as the upstream side of the exhaust gas, and the second end surface 106 is defined as the downstream side of the exhaust gas, the distinction between the first end surface and the second end surface is for convenience, and the second end surface 106 may be on the upstream side of the exhaust gas, and the first end surface 104 may be on the downstream side of the exhaust gas.

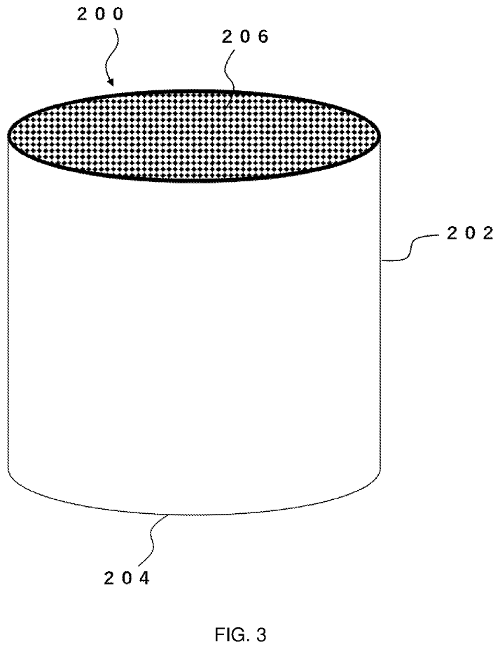

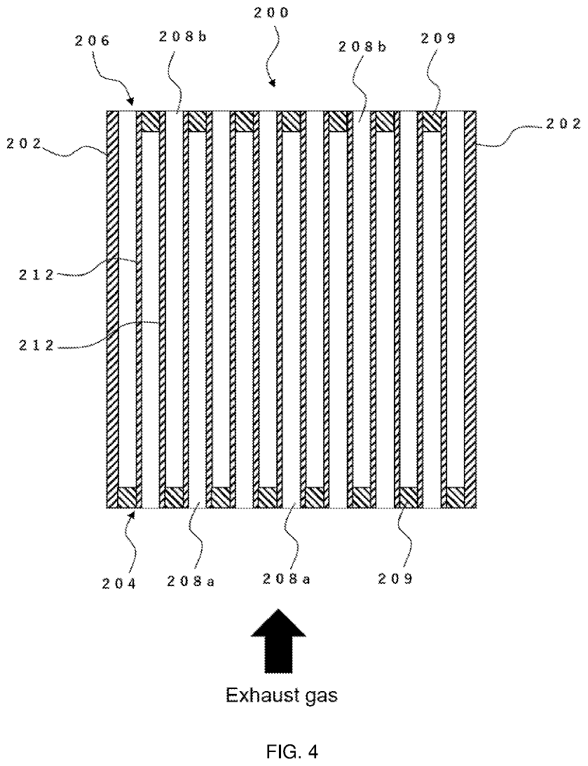

FIGS. 3 and 4 illustrate a schematic perspective view and a cross-sectional view of a wall flow type honeycomb structure 200, respectively. This honeycomb structure 200 comprises an outer peripheral side wall 202; and porous partition walls 212 disposed on the inner peripheral side of the outer peripheral side wall 202 and partitioning a plurality of cells 208a and 208b that form fluid flow paths (cell channels) from a first end surface 204 to a second end surface 206. In the honeycomb structure 200, the plurality of cells 208a, 208b can be classified into a plurality of first cells 208a disposed inside the outer peripheral side wall 202, extending from the first end surface 204 to the second end surface 206, opening on the first end surface 204 and having sealing portions 209 on the second end surface 206; and a plurality of second cells 208b disposed inside the outer peripheral side wall 202, extending from the first end surface 204 to the second end surface 206, having sealing portions 209 on the first end surface 204 and opening on the second end surface 206. In this honeycomb structure 200, the first cells 208a and the second cells 208b are alternately arranged adjacent to each other with porous partition walls 212 interposed therebetween.

When exhaust gas containing particulate matter such as soot is supplied to the first end surface 204 on the upstream side of the honeycomb structure 200, the exhaust gas is introduced into the first cells 208a and proceeds downstream within the first cells 208a. Since the first cells 208a have sealing portions 209 on the second end surface 206 on the downstream side, the exhaust gas passes through the porous partition walls 212 that partition the first cells 208a and the second cells 208b and flows into the second cells 208b. Since the particulate matter cannot pass through the porous partition walls 212, it is collected and deposited within the first cells 208a. After the particulate matter has been removed, the clean exhaust gas that has entered the second cells 208b travels downstream within the second cells 208b and exits from the second end surface 206 on the downstream side. It should be noted that, although the first end surface 204 is defined as the upstream side of the exhaust gas, and the second end surface 206 is defined as the downstream side of the exhaust gas, the distinction between the first end surface and the second end surface is for convenience, and the second end surface 206 may be on the upstream side of the exhaust gas, and the first end surface 204 may be on the downstream side of the exhaust gas.

The shape of the end surfaces of the honeycomb structure is not limited, and for example, it may be a round shape such as a circular, elliptical, racetrack and elongated circular shape, a polygonal shape such as a triangular and quadrangle shape, and other irregular shapes. The illustrated honeycomb structures have a circular end surface shape is a cylindrical shape as a whole.

The height of the honeycomb structure (the length from the first end surface to the second end surface) is not particularly limited and may be appropriately set according to the application and required performance. There is no particular limitation on the relationship between the height of the honeycomb structure and the maximum diameter of each end surface (referring to the maximum length among the diameters passing through the center of gravity of each end surface of the honeycomb structure). Therefore, the height of the honeycomb structure may be longer than the maximum diameter of each end surface, or the height of the honeycomb structure may be shorter than the maximum diameter of each end surface.

From the viewpoint of pressure loss, the lower limit of the porosity of the porous partition walls of the honeycomb structure is preferably 60% or more, more preferably 62% or more, as measured by a mercury porosimetry. In addition, from the viewpoint of the mechanical strength of the honeycomb structure, the upper limit of the porosity of the porous partition walls as measured by the mercury porosimetry is preferably 70% or less, more preferably 68% or less. Therefore, the porous partition walls preferably have a porosity of, for example, 60 to 70%, more preferably 62 to 68%, as measured by mercury porosimetry. In this specification, “porosity” is measured by the mercury porosimetry specified in JIS R1655:2003. In addition, the measured value of porosity is defined as the average value of the porosity of samples when the samples (0.3 g each) of porous partition walls are collected without bias from six locations of the porous honeycomb structure and the porosity of each sample is determined.

Further, it is desirable that the porous partition walls have a sharp pore diameter distribution in order to achieve both high particulate collection efficiency and low pressure loss performance at a higher level. Specifically, for the porous partition walls, in a volume-based cumulative pore diameter distribution measured by the mercury porosimetry, a cumulative 10% pore diameter (D10), a cumulative 50% pore diameter (D50) and a cumulative 90% pore diameter (D90) from a small pore side preferably satisfy a relationship (D90−D10)/D50≤1.2, more preferably satisfy a relationship (D90−D10)/D50≤1.1, and even more preferably satisfy a relationship (D90−D10)/D50≤1.0. The lower limit of (D90−D10)/D50 is 0, but from the viewpoint of ease of manufacture, it is normal to satisfy 0.5≤(D90−D10)/D50, and typically 0.8≤(D90−D10)/D50. Therefore, the porous partition walls can satisfy, for example, 0.5≤(D90−D10)/D50≤1.2, preferably 0.8≤(D90−D10)/D50≤1.1.

Conventionally, when porous partition walls have a high porosity as described above and contain a high proportion of crystalline cordierite, it has been difficult to obtain such a sharp pore diameter distribution. This is because cordierite crystals tend to have a broad pore diameter distribution due to the difficulty to control the pores that are formed during firing, and also because it is difficult to control pores that are generated from the gaps between the particles of the cordierite-forming raw material. However, by setting the content of crystalline cordierite a little lower, adding ceria, and introducing improvement to the manufacturing method as described below, it is possible to obtain such a sharp pore diameter distribution. This makes it possible to achieve both high particulate collection efficiency and low pressure loss performance at a higher level while taking advantage of the excellent thermal shock resistance which is a characteristic of crystalline cordierite.

In this specification, D10, D50, and D90 of the porous partition walls are measured by the mercury porosimetry specified in JIS R1655: 2003 using a mercury porosimeter. The mercury porosimetry is a method in which a sample is immersed in mercury in a vacuum state, and uniform pressure is applied, and mercury is injected into the sample while the pressure is gradually increased. The pore diameter distribution is calculated from the pressure and the volume of mercury intruded into the pores. When the pressure is gradually increased, mercury is intruded into the pores starting from large diameter, increasing the cumulative capacity of mercury. Finally, when all the pores are filled with mercury, the cumulative capacity reaches an equilibrium amount. The cumulative capacity at this time is the total pore volume (cm³/g). In addition, the pore diameter at the time when 10% of the total pore volume of mercury is intruded from the small pore side is the cumulative 10% pore diameter (D10), the pore diameter at the time when mercury with a volume of 50% of the total pore volume is intruded from the small pore side is the cumulative 50% pore diameter (D50), and the pore diameter at the time when 90% of the total pore volume of mercury is intruded from the small pore side is the cumulative 90% pore diameter (D90).

Samples (0.3 g each) of porous partition walls are collected without bias from six locations of the honeycomb structure, and the pore diameter distribution of each is measured to determine D10, D50, and D90, and the average value is taken as the measured value.

It is desirable that the D50 of the partition walls be set within an appropriate range depending on the application. For example, when using a pillar-shaped honeycomb structure as a filter, the D50 of the porous partition walls is preferably 20 μm or less, and more preferably 18 μm or less. When D50 of the porous partition walls is within the above range, particulate matter collection efficiency is significantly improved. Further, D50 of the porous partition walls is preferably 10 μm or more, and more preferably 12 μm or more. When D50 of the porous partition walls is within the above range, an increase in pressure loss can be suppressed. Therefore, the D50 of the porous partition wall is, for example, preferably 10 to 20 μm, more preferably 12 to 18 μm.

Similarly, it is desirable that the cumulative 10% pore diameter (D10) and cumulative 90% pore diameter (D90) of the porous partition walls are set within appropriate ranges depending on the application. For example, when using a honeycomb structure as a filter, it is preferable that D10 is 8 μm or more and D90 is 34 μm or less, more preferable that D10 is 9 μm or more and D90 is 32 μm or less, and even more preferable that D10 is 10 μm or more and D90 is 30 μm or less. Controlling D10 and D90 within such ranges is advantageous in achieving both high particulate collection efficiency and low pressure loss performance at a higher level.

From the viewpoint of sharpening the pore diameter distribution, it is preferable that the honeycomb structure has a content of cordierite (2MgO·2Al₂O₃·5SiO₂), which is the main crystalline phase, of 80.0% by mass or more, more preferably 82.0% or more. However, if the content of cordierite, which is the main crystalline phase, is too high, it becomes difficult to sharpen the pore diameter distribution. Therefore, in the honeycomb structure, the content of cordierite, which is the main crystalline phase, is preferably 94.0% by mass or less, more preferably 90.0% by mass or less. Therefore, in the honeycomb structure, the content of cordierite, which is the main crystalline phase, is preferably 80.0 to 94.0% by mass, and more preferably 82.0 to 90.0% by mass.

The honeycomb structure (particularly the outer peripheral side walls and the partition walls) preferably contains ceria in a secondary crystalline phase from the viewpoint of sharpening the pore diameter distribution. Furthermore, from the viewpoint of sharpening the pore diameter distribution, it is preferable that the secondary crystalline phase contains one or more compounds selected from mullite, spinel, sapphirine, and cristobalite. In the honeycomb structure (especially the outer peripheral side walls and the partition walls), the lower limit of the total content of ceria and the one or more compounds selected from mullite, spinel, sapphirine, and cristobalite is preferably 4.0% by mass or more, more preferably 6.0% by mass or more, and even more preferably 8.0% by mass or more, from the viewpoint of sharpening the pore diameter distribution. In the honeycomb structure (especially the outer peripheral side walls and the partition walls), the upper limit of the total content of ceria and the one or more compounds selected from mullite, spinel, sapphirine, and cristobalite is preferably 20.0% by mass or less, more preferably 18.5% by mass or less, and even more preferably 17.5% by mass or less, from the viewpoint of collection performance. Therefore, in one embodiment, in the honeycomb structure (especially the outer peripheral side walls and the partition walls), the total content of ceria and the one or more compounds selected from mullite, spinel, sapphirine, and cristobalite is preferably 4.0 to 20.0% by mass, more preferably 6.0 to 18.5% by mass, and even more preferably 8.0 to 17.5% by mass.

In the honeycomb structure (especially the outer peripheral side walls and the partition walls), the lower limit of the content of ceria is more preferably 0.5% by mass or more, and even more preferably 1.0% by mass or more, from the viewpoint of sharpening the pore diameter distribution. In the honeycomb structure (especially the outer peripheral side walls and the partition walls), the upper limit of the content of ceria is preferably 5.0% by mass or less, and more preferably 4.0% by mass or less, from the viewpoint of collection performance. Therefore, in one embodiment, in the honeycomb structure (especially the outer peripheral side walls and the partition walls), the content of ceria is preferably 0.5 to 5.0% by mass, and more preferably 1.0 to 4.0% by mass.

In the honeycomb structure, the content of cordierite, which is the main crystalline phase, and the content of compounds such as ceria, which are contained in the secondary crystalline phase, are measured by the following method.

A sample (3.0 g) of the porous partition walls is taken from two locations, one at the radial center and the other near the outer periphery at the center in the height direction of the honeycomb structure, and each sample is crushed to prepare a measurement sample. For each measurement sample, X-ray analysis measurement is performed in the range of 2θ=8 to 100° using the X-ray diffraction method using with Kα rays of Cu, and an analysis is performed using the Rietveld analysis program RIETAN to determine the mass content of each of cordierite, ceria, mullite, spinel, sapphirine, and cristobalite. Then, the average value of the mass content of each compound in the two measurement samples is taken as the mass content of each compound, and the sum of the average values of the content of each compound is taken as the total content.

It is preferable that the coefficient of linear thermal expansion of the honeycomb structure from 40° C. to 800° C. in the direction in which the cell channels extend is low. For example, the honeycomb structure according to one embodiment of the present invention has a sufficient amount of cordierite crystals, so that it may have the coefficient of linear thermal expansion ranging from 0.6×10⁻⁶/K to 2.0×10⁻⁶/K, typically from 0.6×10⁻⁶/K to 1.8×10⁻⁶/K. The coefficient of linear thermal expansion is measured according to JIS R1618: 2002.

A sample for measuring the coefficient of linear thermal expansion of the honeycomb structure is collected according to the following procedure. From the center of the honeycomb structure in the radial and height directions, a prismatic sample with a size of 3 mm×3 mm×20 mm (length in the direction in which the cells extend) is cut out from the honeycomb structure. The coefficient of linear thermal expansion of the sample is measured under the above-mentioned temperature change conditions and used as a measured value.

From the viewpoint of ensuring strength, the average thickness of the partition walls in the honeycomb structure is preferably 152 μm or more, more preferably 178 μm or more, and even more preferably 203 μm or more. Further, from the viewpoint of suppressing pressure loss, the average thickness of the partition walls is preferably 305 μm or less, more preferably 279 μm or less, and even more preferably 254 μm or less. Therefore, the average thickness of the partition walls is, for example, preferably 152 to 305 μm, more preferably 178 to 279 μm, and even more preferably 203 to 254 μm. The thickness of the partition wall refers to a crossing length of a line segment that crosses the partition wall when the centers of gravity O of adjacent cells are connected by this line segment in a cross-section orthogonal to the direction in which the cells extend (the height direction of honeycomb structure). The average thickness of partition walls refers to the average value of the thicknesses of all partition walls.

In one embodiment, the sealing portions on the first end surface and the second end surface both have an average depth of 2 to 8 mm. When the average depth of the sealing portions is 2 mm or more, the strength of the sealing portions can be ensured. The average depth of the sealing portions is preferably 3 mm or more. Further, by setting the average depth of the sealing portions to 8 mm or less, it is possible to prevent the area of the partition walls that collect particulate matter within the cell from becoming small. The average depth of the sealing portions is preferably 7 mm or less. The depth of the sealing portions in the direction in which the cells extend is measured at arbitrary 20 locations for each end surface, and the average value thereof is taken as the average depth of the sealing portions of each end surface.

There is no particular restriction on the cell density (number of cells per unit cross-sectional area) of the honeycomb structure, for example, it can be 6 to 2000 cells/square inch (0.9 to 311 cells/cm²), more preferably 50 to 1000 cells/square inch (7.8 to 155 cells/cm²), particularly preferably 100 to 600 cells/square inch (15.5 to 92.0 cells/cm²). Here, the cell density is calculated by dividing the total number of cells (including sealed cells) by the end surface area of one side of the pillar-shaped honeycomb structure excluding the outer peripheral side wall.

When using the honeycomb structure as a catalyst carrier, the surfaces of the partition walls can be coated with a catalyst depending on the purpose. As to the catalyst, although not limited, mention can be made to a diesel oxidation catalyst (DOC) for oxidizing and burning hydrocarbons (HC) and carbon monoxide (CO) to increase exhaust gas temperature, a PM combustion catalyst that assists in the combustion of PM such as soot, an SCR catalyst and an NSR catalyst that remove nitrogen oxides (NOx), as well as a three-way catalyst that can simultaneously remove hydrocarbons (HC), carbon monoxide (CO), and nitrogen oxides (NOx). The catalyst may contain as appropriate, for example, noble metals (Pt, Pd, Rh, and the like), alkali metals (Li, Na, K, Cs, and the like), alkaline earth metals (Mg, Ca, Ba, Sr, and the like.), rare earths (Ce, Sm, Gd, Nd, Y, La, Pr, and the like), transition metals (Mn, Fe, Co, Ni, Cu, Zn, Sc, Ti, Zr, V, Cr, and the like), and the like.

### 2. Manufacturing Method

A method for manufacturing a honeycomb structure according to an embodiment of the present invention will be exemplified as below. First, by kneading a cordierite-forming raw material, a dispersion medium, a pore-forming material, a binder to form a green body, and then extrusion molding the green body, a honeycomb formed body having a plurality of cell channels passing through the inside of the honeycomb formed body and partitioned by porous partition walls is obtained. The honeycomb formed body may have an outer peripheral side wall; and a plurality of cell channels disposed on the inner peripheral side of the outer peripheral side wall, each extending from a first end surface to a second end surface, and having an opening on both the first end surface and the second end surface. Additives such as a dispersant and other ceramic raw materials may be added to the raw material composition as necessary. For extrusion molding, a die having a desired overall shape, cell shape, partition wall thickness, cell density, and the like can be used.

The cordierite-forming raw material is a raw material that becomes cordierite by firing, and can be provided, for example, in the form of a powder. For example, talc, alumina, aluminum hydroxide, silica, and the like can be mixed and used in appropriate proportions. It is desirable that the cordierite-forming raw material has a chemical composition of alumina (Al₂O₃) (including aluminum hydroxide that converts to alumina): 30 to 45% by mass, magnesia (MgO): 11 to 17% by mass, and silica (SiO2): 42 to 57% by mass.

Furthermore, from the viewpoint of sharpening the pore diameter distribution and promoting the formation of cordierite crystals at relatively low temperatures, it is preferable to add ceria as a sintering aid to the raw material composition. Therefore, the lower limit of the content of ceria in the raw material composition or honeycomb formed body is preferably 0.5 parts by mass or more, and more preferably 1.0 parts by mass or more, with respect to 100 parts by mass of the cordierite-forming raw material. From the viewpoint of collection performance, the upper limit of the content of ceria in the raw material composition or the honeycomb formed body is preferably 5.0 parts by mass or less, and more preferably 4.0 parts by mass or less, with respect to 100 parts by mass of the cordierite-forming raw material. Therefore, in one embodiment, the content of ceria in the raw material composition or the honeycomb formed body is preferably 0.5 to 5.0 parts by mass, more preferably 1.0 to 4.0 parts by mass, with respect to 100 parts by mass of the cordierite-forming raw material. In addition, the content of ceria with respect to 100 parts by mass of the cordierite-forming raw material in the honeycomb formed body is equal to Z (parts by mass), which will be described later.

From the viewpoint of enhancing the effect of sharpening the pore diameter distribution in the partition walls and the outer peripheral side wall of the honeycomb structure, it is preferable that the upper limit of the median diameter (D50) of the ceria added to the raw material composition in the volume-based cumulative particle diameter distribution determined by laser diffraction/scattering method is 10 μm or less, more preferably 8 μm or less, and even more preferably 6 μm or less. Further, from the viewpoint of internal defects which may occur due to agglomeration, it is preferable that the lower limit of the median diameter (D50) of the ceria added to the raw material composition in the volume-based cumulative particle diameter distribution determined by laser diffraction/scattering method is 0.1 μm or more, more preferably 0.3 μm or more, and even more preferably 0.5 μm or more. Therefore, for example, the median diameter (D50) of ceria added to the raw material composition is preferably 0.1 to 10 μm, more preferably 0.3 to 8 μm, and even more preferably 0.5 to 6 μm.

Examples of the dispersion medium include water or a mixed solvent of water and an organic solvent such as alcohol, and water is particularly preferably used.

The content of the dispersion medium in the honeycomb formed body before a drying step is preferably 20 to 110 parts by mass, more preferably 25 to 100 parts by mass, and even more preferably 30 to 90 parts by mass, with respect to 100 parts by mass of the cordierite-forming raw material. When the content of the dispersion medium in the honeycomb formed body is 20 parts by mass or more with respect to 100 parts by mass of the cordierite-forming raw material, it is easy to obtain the advantage that the quality of the honeycomb structure is easily stabilized. When the content of the dispersion medium in the honeycomb formed body is 110 parts by mass or less with respect to 100 parts by mass of the cordierite-forming raw material, the amount of shrinkage during drying becomes small and deformation can be suppressed. In this specification, the content of the dispersion medium in the honeycomb formed body refers to a value measured by a loss on drying method.

The pore-forming material is not particularly limited as long as it forms pores after firing, and for example, mention can be made to flour, starch, foamed resin, water absorbent resin, silica gel, carbon (for example, graphite), ceramic balloon, polyethylene, polystyrene, polypropylene, nylon, polyester, acrylic resin, phenol, and the like. As the pore-forming material, one type may be used alone, and two or more types may be used in combination. From the viewpoint of increasing the porosity of the honeycomb structure after firing, the content of the pore-forming material is preferably 3 parts by mass or more, and more preferably 6 parts by mass or more, and even more preferably 9 parts by mass or more, with respect to 100 parts by mass of the cordierite-forming raw material. From the viewpoint of ensuring the strength of the honeycomb structure after firing, the content of the pore-forming material is preferably 30 parts by mass or less, more preferably 27 parts by mass or less, and even more preferably 24 parts by mass or less, with respect to 100 parts by mass of the cordierite-forming raw material. Since the porosity tends to decrease when ceria is added, the amount of pore-forming material required to achieve the same porosity tends to be larger than when ceria is not added.

As the binder, examples include organic binders such as methylcellulose, hydroxypropoxymethylcellulose, hydroxypropylmethylcellulose, hydroxyethylcellulose, hydroxyethylmethylcellulose, carboxymethylcellulose, and polyvinyl alcohol. Further, from the viewpoint of increasing the strength of the honeycomb formed body before firing, the content of the binder is preferably 4 parts by mass or more, more preferably 5 parts by mass or more, and even more preferably 6 parts by mass or more, with respect to 100 parts by mass of the cordierite-forming raw material. From the viewpoint of suppressing the occurrence of fracture due to abnormal heat generation in a firing step, the content of the binder is preferably 9 parts by mass or less, more preferably 8 parts by mass or less, and even more preferably 7 parts by mass or less, with respect to 100 parts by mass of the cordierite-forming raw material. As the binder, one type may be used alone, and two or more types may be used in combination.

As the dispersant, ethylene glycol, dextrin, fatty acid soap, polyether polyol, and the like can be used. As the dispersant, one type may be used alone, and two or more types may be used in combination. The content of the dispersant is preferably 0 to 5 parts by mass with respect to 100 parts by mass of the cordierite-forming raw material.

For drying the honeycomb formed body, conventionally known drying methods such as hot wind drying, microwave drying, dielectric drying, reduced pressure drying, vacuum drying, and freeze drying can be used. Among these, a drying method that combines hot wind drying with microwave drying or dielectric drying is preferable since the entire honeycomb formed body can be dried quickly and uniformly.

When manufacturing a honeycomb structure with sealing portions, after drying the pillar-shaped honeycomb formed body, the openings of predetermined cells of the honeycomb formed body or a dried body obtained by drying the formed body may be sealed with a sealing material. The sealing portions on each of them can be formed by a method of filling the openings of the first cells and the second cells where the sealing portions are to be formed with a slurry for forming sealing portions, and then drying and firing the filled slurry. The slurry for forming sealing portions may be prepared according to a known composition, and may contain, for example, a cordierite-forming raw material, a dispersion medium, a pore-forming material, and a binder. The slurry for forming sealing portions may contain ceria.

As one example, the slurry for forming sealing portions contains 30 to 60 parts by mass of a dispersion medium, 5 to 20 parts by mass of a pore-forming material, and 0.2 to 2.0 parts by mass of a binder, with respect to 100 parts by mass of the cordierite-forming raw material. In a preferred embodiment, the slurry for forming sealing portions contains 35 to 50 parts by mass of a dispersion medium, 8 to 16 parts by mass of a pore-forming material, and 0.2 to 1.5 parts by mass of a binder, with respect to 100 parts by mass of the cordierite-forming raw material.

Examples of the dispersion medium include water or a mixed solvent of water and an organic solvent such as alcohol, and water is particularly preferably used.

The pore-forming material is not particularly limited as long as it forms pores after firing, and for example, mention can be made to flour, starch, foamed resin, water absorbent resin, silica gel, carbon (for example, graphite), ceramic balloon, polyethylene, polystyrene, polypropylene, nylon, polyester, acrylic resin, phenol, and the like. As the pore-forming material, one type may be used alone, and two or more types may be used in combination.

As the binder, examples include organic binders such as methylcellulose, hydroxypropoxymethylcellulose, hydroxypropylmethylcellulose, hydroxyethylcellulose, hydroxyethylmethylcellulose, carboxymethylcellulose, and polyvinyl alcohol. As the binder, one type may be used alone, and two or more types may be used in combination.

The slurry for forming sealing portions may contain a dispersant as appropriate. The dispersant can be contained, for example, in an amount of 0 to 2.0 parts by mass with respect to 100 parts by mass of the cordierite-forming raw material. Examples of the dispersant include ethylene glycol, dextrin, fatty acid soap, and polyalcohol, and the like. As the dispersant, one type may be used alone, and two or more types may be used in combination.

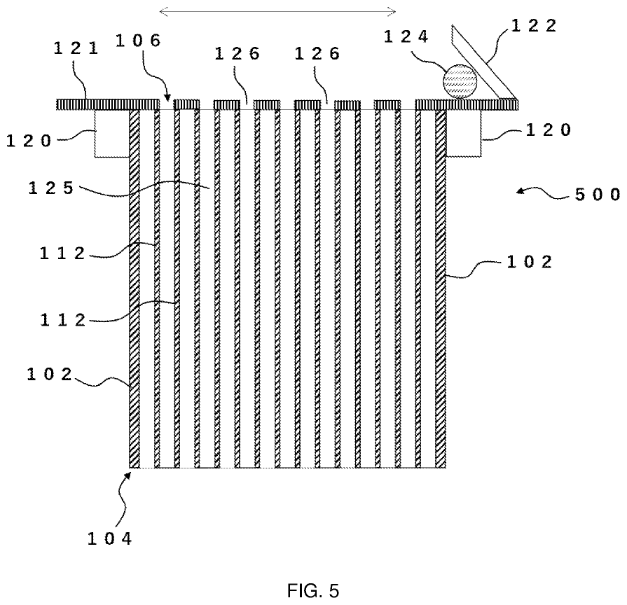

Filling the openings of the cells with the slurry for forming sealing portions can be carried out by, for example, the following “squeegee method”. As shown in FIG. 5, a film 121 is attached to the upper end surface (here, the second end surface 106 in the figure) of a dried honeycomb formed body 500 which is fixed with a chuck 120, and a plurality of holes 126 are formed in the film 121 by irradiating the film 121 with a laser at positions corresponding to the arrangement condition of the sealing portions (for example, a “checkered pattern” or the like).

Thereafter, the slurry for forming sealing portions 124 is applied on the film 121, and a squeegee 122 is moved along the film 121 in the direction of the arrow in FIG. 5. As a result, the cells 125 opened at positions corresponding to the holes 126 of the film 121 are filled with a certain amount of the slurry for forming sealing portions 124.

The depth of the sealing portions can be changed depending on the number of times the squeegee 122 is moved, the contact angle between the squeegee 122 and the film 121, the pressure of the squeegee 122 against the film 121, and the viscosity of the slurry for forming sealing portions 124, and the like.

After filling the slurry for forming sealing portions 124, the film 121 is peeled off and the entire honeycomb formed body 500 is dried. As a result, the slurry for forming sealing portions 124 filled in the cells 125 is dried, and sealing portions before firing are formed. Drying can be carried out, for example, at a drying temperature of 100 to 230° C. for about 60 to 100 seconds. After drying, the sealing portions protrude from the end surface of the honeycomb formed body by the thickness of the film, so they can be scraped off if necessary.

The material of the film is not particularly limited, but polypropylene (PP), polyethylene terephthalate (PET), polyimide, or Teflon (registered trademark) are preferable because they can be easily thermally processed to form holes. Further, the film preferably has an adhesive layer, and the material of the adhesive layer may be acrylic resin, rubber-based (for example, rubber whose main component is natural rubber or synthetic rubber), or silicon-based resin. preferable. As the film, for example, an adhesive film having a thickness of 20 to 50 μm can be suitably used.

In addition to the above-mentioned “squeegee method”, a “press-in method” can be cited as a method for filling the openings of cells with the slurry for forming sealing portions. The “press-in method” is a method of immersing the end surface of the honeycomb formed body with a film attached and holes provided in a liquid tank containing the slurry for forming sealing portions, and filling the cells with the slurry for forming sealing portions. In this case, the depth of the sealing portions can be changed depending on the depth at which the honeycomb formed body is immersed in the slurry for forming the sealing portions.

After the honeycomb formed body is filled with the slurry for forming sealing portions as necessary, it is then subjected to a degreasing process and a firing process, thereby manufacturing a honeycomb structure. The combustion temperature of the binder is about 200° C., and the combustion temperature of the pore-forming material is about 300 to 1000° C. Therefore, the degreasing step may be carried out by heating the honeycomb formed body to a temperature in the range of about 200 to 1000° C. The heating time is not particularly limited, but is usually about 10 to 100 hours. The honeycomb formed body after the degreasing process is called a calcined body.

In the firing step, assuming the maximum temperature during the firing is X (° C.), the holding time at the maximum temperature is Y (hr), and the content of ceria with respect to 100 parts by mass of the cordierite-forming raw material in the honeycomb formed body is Z (parts by mass), in order to sharpen the pore diameter distribution while ensuring the necessary amount of cordierite crystals, it is preferable to perform the firing such that (Formula 1) is satisfied, more preferable to perform the firing such that (Formula 2) is satisfied, and even more preferable to perform the firing such that (Formula 3) is satisfied.

$$160 \leq ( X - 1345 ) \times Y \times {( Z + 0.5 )}^{2} \leq 7680 \qquad ( Formula 1 )$$

$$160 \leq ( X - 1345 ) \times Y \times {( Z + 0.5 )}^{2} \leq 4 \; 840 \qquad ( Formula 2 )$$

$$160 \leq ( X - 1345 ) \times Y \times {( Z + 0.5 )}^{2} \leq 3720 \qquad ( Formula 3 )$$

The firing step is preferably performed on the calcined body.

Mullite, spinel, sapphirine, and cristobalite do not need to be added to the raw material composition, and an appropriate amount is generated as a by-product during the firing under the above conditions, and constitutes a secondary crystalline phase.

From the viewpoint of sharpening the pore diameter distribution, X (° C.) is preferably 1430 or less, more preferably 1400 or less, and even more preferably 1380 or less. From the viewpoint of promoting the formation of cordierite crystals, X (° C.) is preferably 1345 or more, more preferably 1350 or more, and even more preferably 1355 or more. Therefore, X (° C.) is preferably, for example, 1345 to 1430, more preferably 1350 to 1400, and even more preferably 1355 to 1380.

From the viewpoint of ease of manufacture, Y (hr) is preferably 24 or less, more preferably 16 or less. From the viewpoint of promoting the formation of cordierite crystals, Y (hr) is preferably 7 or more, and more preferably 12 or more. Therefore, Y (hr) is, for example, preferably from 7 to 24, more preferably from 12 to 16.

The preferable conditions for Z (parts by mass) are as described above.

### EXAMPLES

Hereinafter, Examples will be illustrated to better understand the present invention and its advantages, but the present invention is not limited to the Examples.

### Manufacture of Honeycomb Structure (Comparative Examples 1 to 5, Examples 1 to 9)

### (1) Preparation of Pillar-Shaped Honeycomb Formed Body

A raw material composition obtained by adding a cordierite forming raw material, a dispersion medium, a pore former, a binder, a dispersant, and a sintering aid in the mass ratios listed in Table 1 was kneaded, thereby preparing a green body. As the cordierite-forming raw material, talc, alumina, aluminum hydroxide, and silica were used. Water was used as the dispersion medium. Acrylic polymer was used as the pore-forming material. Methyl cellulose was used as the binder, and ethylene glycol was used as the dispersant. Ceria (median diameter in the volume-based cumulative particle diameter distribution determined by laser diffraction/scattering method=1.0 μm) was used as the sintering aid.

This green body was put into an extrusion molding machine and extrusion molded through a die of a predetermined shape to obtain a cylindrical pillar-shaped honeycomb formed body. After dielectrically drying and hot wind drying the obtained pillar-shaped honeycomb formed body, and further by hot wind drying, both end surfaces were cut to a predetermined size.

### (2) Formation of Sealing Portions

A raw material composition obtained by adding 40 parts by mass of a dispersion medium, 10 parts by mass of a pore-forming material, 2 parts by mass of a binder, and 1 part by mass of a dispersant to 100 parts by mass of a cordierite-forming raw material was kneaded, thereby preparing a slurry for forming sealing portions. As the cordierite-forming raw material, talc, alumina, aluminum hydroxide, and silica were used. Water was used as the dispersion medium, foamed resin was used as the pore-forming material, methyl cellulose was used as the binder, and ethylene glycol was used as the dispersant. Using the above-mentioned “squeegee method”, both end surfaces were filled with this slurry for forming sealing portions such that the first cells and the second cells were alternately arranged adjacent to each other. Thereafter, drying was performed at 180° C. for 200 seconds in an air atmosphere.

### (3) Firing

Next, a pillar-shaped honeycomb structure having sealing portions was obtained by heating and degreasing at about 200° C. in an air atmosphere, and then firing in the air atmosphere under the conditions of the maximum temperature and the holding time at the maximum temperature listed in Table 1. Assuming the maximum temperature during the firing is X (° C.), the holding time at the maximum temperature is Y (hr), and the content of ceria with respect to 100 parts by mass of the cordierite-forming raw material in the honeycomb formed body is Z (parts by mass), the value of (X−1345)×Y×(Z+0.5)² is shown in Table 1. A number of pillar-shaped honeycomb structures required for the following tests was manufactured.

### (4) Specifications of Pillar-Shaped Honeycomb Structure

The specifications of the obtained honeycomb structure were as follows.

Overall shape: cylindrical with diameter 132 mm×height 152 mm

Cell shape in a cross-section perpendicular to cell flow path direction: square

Cell density (number of cells per unit cross-sectional area): 300 cells/square inch (47 cells/cm²)

Average thickness of partition wall: 8.5 mil (216 μm) (nominal value based on the specifications of the die)

Average depth of sealing portions: 5 mm

### Characteristics Evaluation

Various characteristic evaluations were performed on each honeycomb structure obtained above.

### 1. Porosity

The porosity (%) of the honeycomb structure was determined according to the mercury porosimetry described above. The results are shown in Table 1.

### 2. Pore Diameter Distribution of Porous Partition Walls

For the porous partition walls of the honeycomb structure, the volume-based cumulative pore diameter distribution was measured by the mercury porosimetry described above, and the cumulative 10% pore diameter (D10), the cumulative 50% pore diameter (D50), and the cumulative 90% pore diameter (D90) from the small pore side, and (D90−D10)/D50 were determined. The results are shown in Table 1.

### 3. Coefficient of Linear Thermal Expansion: CTE

A sample was taken from the center in the radial and height directions of the honeycomb structure using the method described above, and the coefficient of linear thermal expansion from 40° C. to 800° C. in the extending direction of the cell channels of the honeycomb structure was measured according to JIS R1618: 2002. The results are shown in Table 1.

### 4. Composition Analysis

The composition of the honeycomb structure was analyzed using the X-ray diffraction method described above using a X'pert PRO device manufactured by PANalytical, and the mass content of cordierite, mullite, spinel, sapphirine, cristobalite, and ceria was determined respectively. The results are shown in Table 1.

### 5. Evaluation of Filter Performance

### (5-1) Collection Performance

The honeycomb structure was connected to the outlet side of an engine exhaust manifold of a 1.2 L direct injection gasoline engine vehicle, and the number of soot contained in the gas discharged from the outlet of the exhaust gas purification device was measured by the PN measurement method. Regarding the driving mode, a driving mode (RTS95) that simulates the worst of RDE driving was implemented. The total number of soot discharged after the mode driving was taken as the number of soot in the honeycomb structure to be evaluated, and the collection efficiency (%) was calculated from the number of soot. In the “Collection performance” column of Table 1, the honeycomb filter of each Example and Comparative Example was evaluated based on the following evaluation criteria, with the value of the collection efficiency of the honeycomb structure of Comparative Example 1 set as 100%. The results are shown in Table 1.
Evaluation “double circle”: the value of collection efficiency ratio (%) exceeded 110%
Evaluation “circle”: the value of collection efficiency ratio (%) exceeded 105% and was no more than 110%
Evaluation “triangle”: the value of collection efficiency ratio (%) exceeded 100% and was no more than 105%
Evaluation “cross”: the value of collection efficiency ratio (%) was no more than 100%

### (5-2) Pressure Loss

Exhaust gas discharged from a 1.2 L direct injection gasoline engine was allowed to flow in at 700° C. and at a flow rate of 600 m³/h, and the pressures on the inlet end surface side and the outlet end surface side of the honeycomb structure were measured. Then, the pressure loss (kPa) of the honeycomb structure was determined by calculating the pressure difference between the inflow end surface side and the outflow end surface side. In the “Pressure loss” column of Table 1, the pressure loss value (%) of the honeycomb structure of each Example and Comparative Example is shown, with the value of pressure loss of the honeycomb structure of Comparative Example 1 set as 100%. In the pressure loss evaluation, the honeycomb filter of each Example was evaluated based on the following evaluation criteria. The results are shown in Table 1.
Evaluation “double circle”: the value of pressure loss ratio (%) was no more than 90%
Evaluation “circle”: the value of pressure loss ratio (%) exceeded 90% and was no more than 95%
Evaluation “triangle”: the value of pressure loss ratio (%) exceeded 95% and was no more than 100%
Evaluation “cross”: the value of pressure loss ratio (%) exceeded 100%

### (5-3) Thermal Shock Resistance

The honeycomb structure was placed in an electric furnace preheated to room temperature+550° C., and after heating for a sufficient time (30 minutes) so that the entire honeycomb structure reached the same temperature as the heating temperature of the electric furnace, it was air cooled to room temperature at a cooling rate of 50° C./min. It was examined whether cracks were generated on the side surfaces, end surfaces, or inside of the honeycomb structure due to thermal shock during this cooling. If no cracks occurred when the sample was cooled to room temperature, it was considered that the test for the heating temperature had been cleared. The presence or absence of cracks was inspected visually, by tapping sound, or the like. For the cleared honeycomb structures, the heating temperature of the electric furnace was increased by 50° C., and the above test was repeated until cracks occurred. In the evaluation of thermal shock resistance, the honeycomb filters of each Example were evaluated based on the following evaluation criteria. The results are shown in Table 1.
Evaluation “cross”: cracks occurred at room temperature+550° C.
Evaluation “triangle”: cleared up to room temperature+550° C.
Evaluation “circle”: cleared up to room temperature+600° C.
Evaluation “double circle”: cleared up to room temperature+650° C.

TABLE 1

| | | | Compartive | Compartive | Compartive | Compartive | Compartive | | |
|---|---|---|---|---|---|---|---|---|---|
| | | | Example | Example | Example | Example | Example | Example | Example |
| | | | 1 | 2 | 3 | 4 | 5 | 1 | 2 |
| Raw material | Cordierite-forming | Talc | 40 | | | | | | |
| composition | raw material | Alumina | 20 | | | | | | |
| (mass ratio) | | Aluminum | 20 | | | | | | |
| | | hydroxide | | | | | | | |
| | | Silica | 20 | | | | | | |
| | Dispersion medium | Water | 90 | | | | | | |
| | Pore forming | Acrylic | 3 | | | | | | |
| | material | polymer | | | | | | | |
| | Binder | Methyl | 8 | | | | | | |
| | | cellulose | | | | | | | |
| | Dispersant | Ethylene | 1 | | | | | | |
| | | glycol | | | | | | | |
| | Sintering aid | Celia | 0 | 0 | 3.5 | 5 | 7 | 0.5 | 0.5 |
| Firing | Maximum | | 1430 | 1375 | 1430 | 1375 | 1355 | 1430 | 1375 |
| conditions | temperature | | | | | | | | |
| | during firing X (C.) | | | | | | | | |
| | Maximum | | 7 | 16 | 7 | 16 | 16 | 7 | 16 |
| | temperature | | | | | | | | |
| | holding time Y (hr) | | | | | | | | |
| | (X-1345) × | | 149 | 120 | 9520 | 14520 | 9000 | 595 | 480 |
| | Yx(Z + 0.5)² | | | | | | | | |
| Characteristic | Porosity (%) | | 65.3 | 61.3 | 62.8 | 61.4 | 59.7 | 64.7 | 65.5 |
| evaluation | D50 (μm) | | 16.3 | 17.5 | 18.5 | 22.4 | 22.1 | 16 | 14.7 |
| | D90 (μm) | | 29.9 | 53.2 | 38.5 | 46.2 | 41.4 | 31.8 | 25.6 |
| | D10 (μm) | | 7.1 | 9.2 | 15.3 | 16.6 | 16.7 | 12.9 | 10.3 |
| | (D90-D10/D50 | | 1.40 | 2.51 | 1.25 | 1.32 | 1.12 | 1.18 | 1.04 |
| | CTE (ppm/K) | | 0.5 | 2.2 | 1.5 | 1.5 | 1.4 | 0.7 | 1.7 |
| | Cordierite (mass %) | | 95.1 | 79.2 | 84.5 | 84.5 | 78.5 | 93.7 | 88.6 |
| | Mullite (mass %) | | 1. | 0.2 | 0.5 | 0.5 | 0.3 | 1.0 | 0.5 |
| | Spinel (mass %) | | 0.7 | 4.1 | 2.9 | 2.9 | 3.5 | 0.7 | 2.9 |
| | Sapphirin (mass %) | | 1.9 | 6.4 | 3.9 | 3.9 | 5.5 | 2.0 | 3.8 |
| | Cristobalite (mass %) | | 0.0 | 6.0 | 1.9 | 1.9 | 4.2 | 0.0 | 1.8 |
| | Ceria (mass %) | | 0.0 | 0.0 | 5.0 | 5.0 | 7.0 | 0.5 | 0.5 |
| Filter | Collection | | Reference | X | X | X | Δ | ◯ | ◯ |
| performance | performance | | | | | | | | |
| | Pressure loss | | Reference | Δ | Δ | Δ | X | ◯ | ◯ |
| | Thermal shock | | ⊚ | Δ | ◯ | ◯ | ◯ | ⊚ | ◯ |
| | resistance | | | | | | | | |
| | | | Example | Example | Example | Example | Example \| | Example | Example |
| | | | 3 | 4 | 5 | 6 | 7 | 8 | 9 |
| Raw material | Cordierite-forming | Talc | 40 | | | | | | |
| composition | raw material | Alumina | 20 | | | | | | |
| (mass ratio) | | Aluminum | 20 | | | | | | |
| | | hydroxide | | | | | | | |
| | | Silica | 20 | | | | | | |
| | Dispersion medium | Water | 90 | | | | | | |
| | Pore forming | Acrylic | 3 | | | | | | |
| | material | polymer | | | | | | | |
| | Binder | Methyl | 8 | | | | | | |
| | | cellulose | | | | | | | |
| | Dispersant | Ethylene | 1 | | | | | | |
| | | glycol | | | | | | | |
| | Sintering aid | Celia | 0.5 | 2 | 2 | 2 | 3.5 | 3.5 | 5 |
| Firing | Maximum | | 1355 | 1430 | 1375 | 1355 | 1375 | 1355 | 1355 |
| conditions | temperature | | | | | | | | |
| | during firing X (C.) | | | | | | | | |
| | Maximum | | 16 | 7 | 16 | 16 | 16 | 16 | 16 |
| | temperature | | | | | | | | |
| | holding time Y (hr) | | | | | | | | |
| | (X-1345) × | | 160 | 3719 | 3000 | 1000 | 7680 | 2560 | 4840 |
| | Yx(Z + 0.5)² | | | | | | | | |
| Characteristic | Porosity (%) | | 66.6 | 64.2 | 65.1 | 65.5 | 63.5 | 64.6 | 62.4 |
| evaluation | D50 (μm) | | 13.5 | 16.8 | 15.9 | 15.2 | 17.3 | 15.5 | 18.4 |
| | D90 (μm) | | 23.1 | 33.5 | 28.3 | 23.7 | 30.5 | 27.7 | 33.5 |
| | D10 (μm) | | 10.3 | 13.8 | 12 | 11.3 | 12.9 | 11.5 | 13.1 |
| | (D90-D10)/D50 | | 0.95 | 1.19 | 1.03 | 0.82 | 1.02 | 1.05 | 1.11 |
| | CTE (ppm/K) | | 1.8 | 0.6 | 1.6 | 1.7 | 1.5 | 1.7 | 1.6 |
| | Cordierite (mass %) | | 84.4 | 92.3 | 87.5 | 83.5 | 86.5 | 82.5 | 80.5 |
| | Mullite (mass %) | | 0.3 | 1.7 | 0.5 | 0.3 | 0.5 | 0.3 | 0.3 |
| | Spinel (mass %) | | 3.5 | 0.7 | 2.9 | 3.5 | 2.9 | 3.5 | 3.4 |
| | Sapphirin (mass %) | | 5.6 | 1.9 | 3.9 | 5.5 | 3.9 | 6.2 | 5.5 |
| | Cristobalite (mass %) | | 4.1 | 0.0 | 1.8 | 4.4 | 1.8 | 3.7 | 4.2 |
| | Ceria (mass %) | | 0.5 | 2.0 | 2.0 | 2.0 | 3.5 | 3.5 | 5.0 |
| Filter | Collection | | ⊚ | ◯ | ◯ | ⊚ | ◯ | ◯ | Δ |
| performance | performance | | | | | | | | |
| | Pressure loss | | ◯ | ◯ | ◯ | ◯ | ⊚ | ◯ | ⊚ |
| | Thermal shock | | ◯ | ⊚ | ◯ | ◯ | ◯ | ◯ | ◯ |
| | resistance | | | | | | | | |

### 6. Discussion

From the results in Table 1, it can be seen that the honeycomb structures according to the Examples of the present invention were able to achieve high levels of thermal shock resistance, high particulate collection efficiency, and low pressure loss performance. In Comparative Examples 1 to 4, at least one of the cordierite content, porosity, presence or absence of ceria, and (D90−D10)/D50 was inappropriate, so the evaluation of collection performance or pressure loss was evaluated as cross.

### DESCRIPTION OF REFERENCE NUMERALS

100: Honeycomb structure
102: Outer peripheral side wall
104: First end surface
106: Second end surface
108: Cell
112: Porous partition wall
120: Chuck
121: Film
122: Squeegee
124: Slurry for forming sealing portions
125: Cell
126: Hole
200: Honeycomb structure
202: Outer peripheral side wall
204: First end surface
206: Second end surface
208a: First cell
208b: Second cell
209: Sealing portion
212: Porous partition wall
500: Honeycomb formed body

1. A honeycomb structure, comprising a plurality of cell channels passing through an inside of the honeycomb structure and partitioned by porous partition walls,
wherein the honeycomb structure comprises 80.0 to 94.0% by mass of cordierite as a main crystalline phase and ceria contained in a secondary crystalline phase;
the porous partition walls have a porosity of 60% or more as measured by a mercury porosimetry; and
for the porous partition walls, a cumulative 10% pore diameter (D10), a cumulative 50% pore diameter (D50) and a cumulative 90% pore diameter (D90) from a small pore side satisfy a relationship (D90−D10)/D50≤1.2, in a volume-based cumulative pore diameter distribution as measured by the mercury porosimetry.

2. The honeycomb structure according to claim 1, wherein the porous partition walls have a cumulative 50% pore diameter (D50) of 10 to 20 μm.

3. The honeycomb structure according to claim 1, wherein the porous partition walls have a cumulative 10% pore diameter (D10) of 8 μm or more and a cumulative 90% pore diameter (D90) of 34 μm or less.

4. The honeycomb structure according to claim 1, wherein the secondary crystalline phase further contains one or more compounds selected from mullite, spinel, sapphirine, and cristobalite.

5. The honeycomb structure according to claim 4, wherein a total content of ceria and one or more compounds selected from mullite, spinel, sapphirine, and cristobalite is 4.0 to 20.0% by mass.

6. The honeycomb structure according to claim 1, wherein a content of ceria is 0.5 to 5.0% by mass.

7. The honeycomb structure according to claim 5, wherein a content of ceria is 0.5 to 5.0% by mass.

8. The honeycomb structure according to claim 1, wherein a coefficient of linear thermal expansion from 40° C. to 800° C. in a direction in which the cell channels extend is 0.6×10⁻⁶/K to 2.0×10⁻⁶/K.

9. A method for manufacturing a honeycomb structure, comprising:
a step of obtaining a honeycomb formed body comprising a plurality of cell channels passing through an inside of the honeycomb formed body and partitioned by porous partition walls by kneading a raw material composition comprising a cordierite-forming raw material, ceria, a dispersion medium, a pore-forming material, and a binder to form a green body, and then extrusion molding the green body; and
a step of firing the honeycomb formed body;
wherein in the step of firing, assuming a maximum temperature during the firing is X (° C.), a holding time at the maximum temperature is Y (hr), and a content of ceria with respect to 100 parts by mass of the cordierite-forming raw material in the honeycomb formed body is Z (parts by mass), the step of firing is performed such that 160≤(X−1345)×Y×(Z+0.5)²≤7680 is satisfied.
